(19) United States
(12) Patent Application Publication
(10) Pub. No.: US 2025/0306424 A1
(43) Pub. Date: Oct. 2, 2025

(54) MULTIPLE-FUNCTION OPTICAL SHEET AND ELECTRONIC PAPER DISPLAY DEVICE

(71) Applicant: E Ink Holdings Inc., HSINCHU (TW)

(72) Inventor: Chia-I LIU, HSINCHU (TW)

(21) Appl. No.: 19/048,980

(22) Filed: Feb. 10, 2025

Related U.S. Application Data
(60) Provisional application No. 63/570,825, filed on Mar. 28, 2024.

(51) Int. Cl. G02F 1/167; G02F 1/1333; G02F 1/1677

(52) U.S. Cl. CPC G02F 1/167; G02F 1/13338; G02F 1/1677; G02F 2201/50; G02F 2202/28

(57) ABSTRACT

A multiple-function optical sheet includes a polymethyl methacrylate (PMMA) film, a first transparent conductive layer, a second transparent conductive layer, and a moisture barrier layer. The first transparent conductive layer is located on the top surface of the PMMA film. The second transparent conductive layer is located below the bottom surface of the PMMA film. The moisture barrier layer is located between the second transparent conductive layer and the PMMA film. The refractive index of the PMMA film, the refractive index of the first transparent conductive layer, the refractive index of the second transparent conductive layer, and the refractive index of the moisture barrier layer are in a range from 1.4 to 2.1.

### CROSS-REFERENCE TO RELATED APPLICATION

This application claims priority to U.S. Provisional Application Ser. No. 63/570,825, filed Mar. 28, 2024, which is herein incorporated by reference.

### BACKGROUND

### Field of Invention

The present disclosure relates to a multiple-function optical sheet and an electronic paper display device having the multiple-function optical sheet.

### Description of Related Art

Generally speaking, various film materials with different functions are used in displays, such as a touch film, a barrier film, a conductive film, etc. The design of multi-layer film materials requires the use of optical clear adhesive (OCA) for adhering. Such a configuration easily causes risks in reliability testing. Furthermore, most of the base materials of film materials are low-cost and easy-to-process polyester materials, such as polyethylene terephthalate (PET). However, the refractive index (1.57˜1.65) of polyethylene terephthalate and the refractive index (1.47˜1.48) of the common commercially available acrylic optical pressure sensitive adhesive (Acrylic OCA) are too different to match.

As a result, when incident light penetrates different interfaces of the display, an excessive difference in refractive index between layers will cause reflection, which is detrimental to the contrast and color saturation of the display, such that it is difficult to improve the optical performance of the display.

### SUMMARY

According to some embodiments of the present disclosure, a multiple-function optical sheet includes a polymethyl methacrylate (PMMA) film, a first transparent conductive layer, a second transparent conductive layer, and a moisture barrier layer. The first transparent conductive layer is located on the top surface of the polymethyl methacrylate film. The second transparent conductive layer is located below the bottom surface of the polymethyl methacrylate film. The moisture barrier layer is located between the second transparent conductive layer and the polymethyl methacrylate film. The refractive index of the polymethyl methacrylate film, the refractive index of the first transparent conductive layer, the refractive index of the second transparent conductive layer, and the refractive index of the moisture barrier layer are in a range from 1.4 to 2.1.

In some embodiments, the refractive index of the polymethyl methacrylate film is in a range from 1.47 to 1.5.

In some embodiments, the moisture barrier layer is in contact with the second transparent conductive layer.

In some embodiments, the first transparent conductive layer is in contact with the polymethyl methacrylate film.

In some embodiments, each of the first transparent conductive layer and the second transparent conductive layer comprises a touch circuit and a conductive circuit.

In some embodiments, a material of the moisture barrier layer comprises silicon oxide or silicon nitride.

In some embodiments, the multiple-function optical sheet further includes a buffer layer. The buffer layer is located between the moisture barrier layer and the polymethyl methacrylate film.

In some embodiments, a refractive index of the buffer layer is in a range from 1.4 to 2.1.

In some embodiments, a refractive index of the buffer layer is in a range from 1.45 to 1.52.

In some embodiments, a hydrophobicity of the buffer layer is less than a hydrophobicity of the moisture barrier layer.

According to some embodiments of the present disclosure, an electronic paper display device includes a display medium layer, a multiple-function optical sheet, and an optical clear adhesive layer. The multiple-function optical sheet is located above the display medium layer and includes a polymethyl methacrylate film, a first transparent conductive layer, a second transparent conductive layer, and a moisture barrier layer. The first transparent conductive layer is located on a top surface of the polymethyl methacrylate film. The second transparent conductive layer is located below a bottom surface of the polymethyl methacrylate film. The moisture barrier layer is located between the second transparent conductive layer and the polymethyl methacrylate film, wherein a refractive index of the polymethyl methacrylate film, a refractive index of the first transparent conductive layer, a refractive index of the second transparent conductive layer, and a refractive index of the moisture barrier layer are in a range from 1.4 to 2.1. The optical clear adhesive layer is located on the first transparent conductive layer.

In some embodiments, a refractive index of the optical clear adhesive layer is the same as the refractive index of the polymethyl methacrylate film.

In some embodiments, the refractive index of the optical clear adhesive layer is in a range from 1.47 to 1.48.

In some embodiments, the optical clear adhesive layer is an acrylic optical pressure sensitive adhesive.

In some embodiments, the electronic paper display device further includes a light guide plate, a light transmissive cover, and another optical clear adhesive layer. The light guide plate is located on the optical clear adhesive layer, such that the optical clear adhesive layer is located between the light guide plate and the first transparent conductive layer of the multiple-function optical sheet. The light transmissive cover is located above the light guide plate. The another optical clear adhesive layer is located between the light guide plate and the light transmissive cover, and has a refractive index in a range from 1.47 to 1.48.

In some embodiments, the electronic paper display device further includes a pressure sensitive adhesive. The pressure sensitive adhesive is located between the display medium layer and the second transparent conductive layer, wherein a refractive index of the pressure sensitive adhesive is the same as the refractive index of the polymethyl methacrylate film.

In the aforementioned embodiments of the present disclosure, since the multiple-function optical sheet includes the polymethyl methacrylate (PMMA) film, the first transparent conductive layer, the second transparent conductive layer, and the moisture barrier layer, and the refractive index of the polymethyl methacrylate film, the refractive index of the first transparent conductive layer, the refractive index of the second transparent conductive layer, and the refractive index of the moisture barrier layer are in a range from 1.4 to 2.1, the reflection of each interface can be effectively reduced when light passes through. Moreover, the electronic paper display device having the multiple-function optical sheet may utilize the refractive index of the polymethyl methacrylate film the same as the refractive index of the overlying optical clear adhesive layer to reduce the reflection phenomenon caused by the excessive difference in interface refractive index when incident light passes through, which is beneficial to the contrast and color saturation of the display device. As a result, the optical performance of the electronic paper display device can be improved, thereby improving product competitiveness.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a cross-sectional view of an electronic paper display device according to one embodiment of the present disclosure.

FIG. 2 is an enlarged view of a multiple-function optical sheet of FIG. 1.

FIG. 3 is a partially schematic view of the electronic paper display device of FIG. 1 when being in operation.

FIG. 4 is a cross-sectional view of a multiple-function optical sheet according to another embodiment of the present disclosure.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

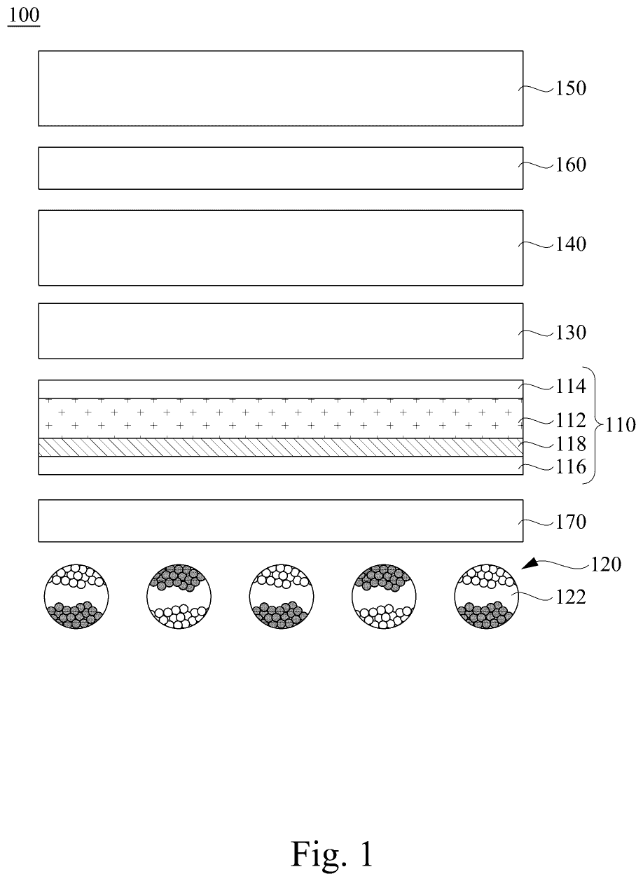

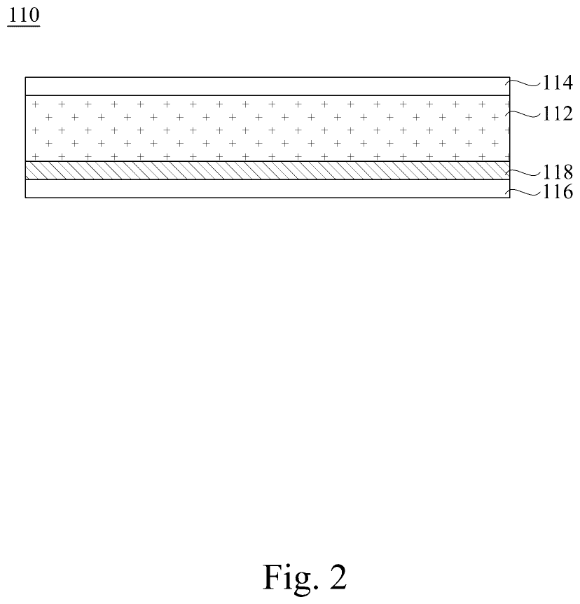

FIG. 1 is a cross-sectional view of an electronic paper display device 100 according to one embodiment of the present disclosure. FIG. 2 is an enlarged view of a multiple-function optical sheet 110 of FIG. 1. As shown in FIG. 1 and FIG. 2, the electronic paper display device 100 includes the multiple-function optical sheet 110, a display medium layer 120, and an optical clear adhesive layer 130. The display medium layer 120 may be an electronic ink layer having plural microencapsules 122. The microencapsule 122 has charged particles, such as black particles and white particles. When the white particles are at upper positions, the white particles can reflect incident light from above to display a light face. When the black particles are at upper positions, the black particles can absorb incident light from above to display a dark face. The multiple-function optical sheet 110 is located above the display medium layer 120. The multiple-function optical sheet 110 includes a polymethyl methacrylate (PMMA) film 112, a first transparent conductive layer 114, a second transparent conductive layer 116, and a moisture barrier layer 118. The first transparent conductive layer 114 is located on the top surface of the polymethyl methacrylate film 112. The second transparent conductive layer 116 is located below the bottom surface of the polymethyl methacrylate film 112. The moisture barrier layer 118 is located between the second transparent conductive layer 116 and the polymethyl methacrylate film 112. Furthermore, the refractive index of the polymethyl methacrylate film 112, the refractive index of the first transparent conductive layer 114, the refractive index of the second transparent conductive layer 116, and the refractive index of the moisture barrier layer 118 are in a range from 1.4 to 2.1. The optical clear adhesive layer 130 is located on the first transparent conductive layer 114.

In some embodiments, each of the first transparent conductive layer 114 and the second transparent conductive layer 116 includes a touch circuit and a conductive circuit, and the material of the first transparent conductive layer 114 and the material of the second transparent conductive layer 116 may be indium tin oxide (ITO). The refractive index of the first transparent conductive layer 114 and the refractive index of the second transparent conductive layer 116 may be 2.0. The first transparent conductive layer 114 may act as a touch sensing electrode (Rx), and the second transparent conductive layer 116 may act as a touch driving electrode (Tx). The material of the moisture barrier layer 118 includes silicon oxide (SiOₓ) or silicon nitride (SiNₓ), and the refractive index of the moisture barrier layer 118 may be in a range from 1.45 to 1.55. The thickness of the polymethyl methacrylate film 112 may be in a range from 10 μm to 100 μm, such as 50 μm. The optical clear adhesive layer 130 may be acrylic optical clear adhesive (Acrylic OCA). In this embodiment, the refractive index of the optical clear adhesive layer 130 is the same as the refractive index of the polymethyl methacrylate film 112. For example, the refractive index of the optical clear adhesive layer 130 and the refractive index of the polymethyl methacrylate film 112 may be in a range from 1.47 to 1.5, such as 1.48.

Specifically, since the multiple-function optical sheet 110 includes the polymethyl methacrylate film 112, the first transparent conductive layer 114, the second transparent conductive layer 116, and the moisture barrier layer 118, and the refractive index of the polymethyl methacrylate film 112, the refractive index of the first transparent conductive layer 114, the refractive index of the second transparent conductive layer 116, and the refractive index of the moisture barrier layer 118 are in a range from 1.4 to 2.1, the reflection of each interface can be effectively reduced when light passes through. Moreover, the electronic paper display device 100 having the multiple-function optical sheet 110 may utilize the refractive index of the polymethyl methacrylate film 112 the same as the refractive index of the overlying optical clear adhesive layer 130 to reduce the reflection phenomenon caused by the excessive difference in interface refractive index when incident light passes through, which is beneficial to the contrast and color saturation of the display device. As a result, the optical performance of the electronic paper display device 100 can be improved, thereby improving product competitiveness. Compared with a configuration using traditional polyethylene terephthalate (PET) film, the electronic paper display device 100 can improve optical contrast by 10% to 20%, and can improve brightness by 5% to 10%.

In this embodiment, the first transparent conductive layer 114 is in direct contact with the polymethyl methacrylate film 112, and the second transparent conductive layer 116 is in direct contact with the moisture barrier layer 118. For example, the first transparent conductive layer 114 and the second transparent conductive layer 116 are respectively directly formed on the top surface of the polymethyl methacrylate film 112 and the bottom surface of the moisture barrier layer 118 by sputtering.

In addition, the electronic paper display device 100 further includes a light guide plate 140, a light transmissive cover 150, and another optical clear adhesive layer 160. The light guide plate 140 is a component of the front light module of the electronic paper display device 100, and is configured to provide light to the display medium layer 120 (e.g., in an operation environment with insufficient ambient light). The refractive index of the light guide plate 140 may be 1.58, but the present disclosure is not limited in this regard. The light transmissive cover 150 is located above the light guide plate 140. The optical clear adhesive layer 160 is located between the light guide plate 140 and the light transmissive cover 150, and has a refractive index in a range from 1.47 to 1.48, such as 1.48. Furthermore, the light guide plate 140 is located on the optical clear adhesive layer 130, such that the optical clear adhesive layer 130 is located between the light guide plate 140 and the first transparent conductive layer 114 of the multiple-function optical sheet 110.

In this embodiment, the electronic paper display device 100 further includes a pressure sensitive adhesive 170. The pressure sensitive adhesive 170 is located between the display medium layer 120 and the second transparent conductive layer 116. The refractive index of the pressure sensitive adhesive 170 is substantially the same as the refractive index of the polymethyl methacrylate film 112, such as 1.48. The pressure sensitive adhesive 170 may include the material of the optical clear adhesive layer 130, but the hardness of the pressure sensitive adhesive 170 and the optical clear adhesive layer 130 may be different.

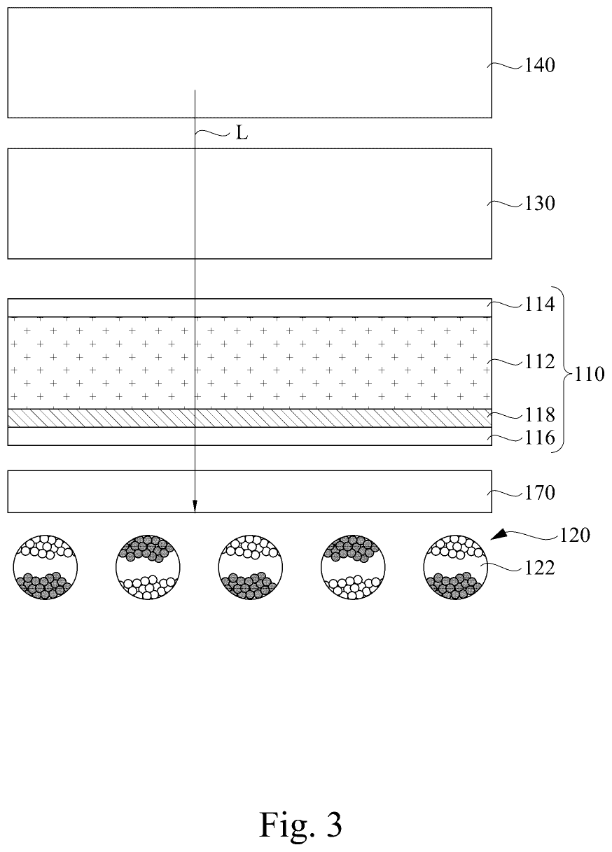

FIG. 3 is a partially schematic view of the electronic paper display device 100 of FIG. 1 when being in operation. As shown in FIG. 3, when the light guide plate 140 is lit to emit an incident light L, because the refractive index of the polymethyl methacrylate film 112, the refractive index of the first transparent conductive layer 114, the refractive index of the second transparent conductive layer 116, and the refractive index of the moisture barrier layer 118 are in a range from 1.4 to 2.1, and the refractive index of optical clear adhesive layer 130, the refractive index of the polymethyl methacrylate film 112, and the refractive index of the pressure sensitive adhesive 170 are substantially the same (e.g., 1.48), the reflection phenomenon can be reduced when the incident light L passes through, thereby ensuring that the incident light L is transmitted to the display medium layer 120 to improve the optical performance of the electronic paper display device 100.

It is to be noted that the connection relationships, the materials, and the advantages of the elements described above will not be repeated in the following description. In the following description, other features of the multiple-function optical sheet will be explained.

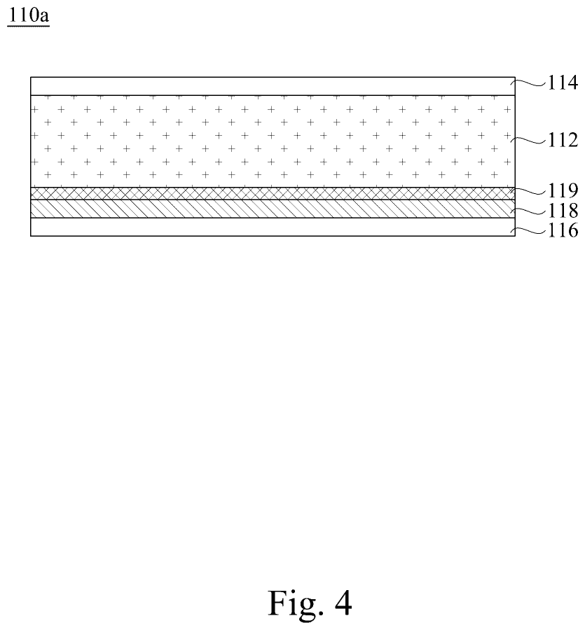

FIG. 4 is a cross-sectional view of a multiple-function optical sheet 110a according to another embodiment of the present disclosure. As shown in FIG. 4, the multiple-function optical sheet 110a includes the polymethyl methacrylate film 112, the first transparent conductive layer 114, the second transparent conductive layer 116, and the moisture barrier layer 118. Moreover, the multiple-function optical sheet 110a further includes a buffer layer 119. The buffer layer 119 is located between the moisture barrier layer 118 and the polymethyl methacrylate film 112. The buffer layer 119 is an under coat layer of the polymethyl methacrylate film 112. The refractive index of the buffer layer 119 is in a range from 1.4 to 2.1. Preferably, the refractive index of the buffer layer 119 is in a range from 1.45 to 1.52.

Since the hydrophobicity of the buffer layer 119 is less than thehydrophobicity of the moisture barrier layer 118, and the polymethyl methacrylate film 112 is hydrophilicity, the configuration of the buffer layer 119 can improve the adhesion between the moisture barrier layer 118 and the polymethyl methacrylate film 112.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A multiple-function optical sheet, comprising:
a polymethyl methacrylate film;
a first transparent conductive layer located on a top surface of the polymethyl methacrylate film;
a second transparent conductive layer located below a bottom surface of the polymethyl methacrylate film; and
a moisture barrier layer located between the second transparent conductive layer and the polymethyl methacrylate film, wherein a refractive index of the polymethyl methacrylate film, a refractive index of the first transparent conductive layer, a refractive index of the second transparent conductive layer, and a refractive index of the moisture barrier layer are in a range from 1.4 to 2.1.

2. The multiple-function optical sheet of claim 1, wherein the refractive index of the polymethyl methacrylate film is in a range from 1.47 to 1.5.

3. The multiple-function optical sheet of claim 1, wherein the moisture barrier layer is in contact with the second transparent conductive layer.

4. The multiple-function optical sheet of claim 1, wherein the first transparent conductive layer is in contact with the polymethyl methacrylate film.

5. The multiple-function optical sheet of claim 1, wherein each of the first transparent conductive layer and the second transparent conductive layer comprises a touch circuit and a conductive circuit.

6. The multiple-function optical sheet of claim 1, wherein a material of the moisture barrier layer comprises silicon oxide or silicon nitride.

7. The multiple-function optical sheet of claim 1, further comprising:
a buffer layer located between the moisture barrier layer and the polymethyl methacrylate film.

8. The multiple-function optical sheet of claim 7, wherein a refractive index of the buffer layer is in a range from 1.4 to 2.1.

9. The multiple-function optical sheet of claim 7, wherein a refractive index of the buffer layer is in a range from 1.45 to 1.52.

10. The multiple-function optical sheet of claim 7, wherein a hydrophobicity of the buffer layer is less than a hydrophobicity of the moisture barrier layer.

11. An electronic paper display device, comprising:
a display medium layer;
a multiple-function optical sheet located above the display medium layer and comprising:
a polymethyl methacrylate film;
a first transparent conductive layer located on a top surface of the polymethyl methacrylate film;
a second transparent conductive layer located below a bottom surface of the polymethyl methacrylate film; and
a moisture barrier layer located between the second transparent conductive layer and the polymethyl methacrylate film, wherein a refractive index of the polymethyl methacrylate film, a refractive index of the first transparent conductive layer, a refractive index of the second transparent conductive layer, and a refractive index of the moisture barrier layer are in a range from 1.4 to 2.1; and
an optical clear adhesive layer located on the first transparent conductive layer.

12. The electronic paper display device of claim 11, wherein a refractive index of the optical clear adhesive layer is the same as the refractive index of the polymethyl methacrylate film.

13. The electronic paper display device of claim 12, wherein the refractive index of the optical clear adhesive layer is in a range from 1.47 to 1.48.

14. The electronic paper display device of claim 11, wherein the optical clear adhesive layer is an acrylic optical pressure sensitive adhesive.

15. The electronic paper display device of claim 11, further comprising:
a light guide plate located on the optical clear adhesive layer, such that the optical clear adhesive layer is located between the light guide plate and the first transparent conductive layer of the multiple-function optical sheet;
a light transmissive cover located above the light guide plate; and
another optical clear adhesive layer located between the light guide plate and the light transmissive cover and having a refractive index in a range from 1.47 to 1.48.

16. The electronic paper display device of claim 11, further comprising:
a pressure sensitive adhesive located between the display medium layer and the second transparent conductive layer, wherein a refractive index of the pressure sensitive adhesive is the same as the refractive index of the polymethyl methacrylate film.
